(19) United States
(12) Patent Application Publication
(10) Pub. No.: US 2017/0049207 A1
(43) Pub. Date: Feb. 23, 2017

(54) LICE REJECTING SCRUNCHIE

(71) Applicant: TOVA TAL, HAIFA (IL)

(72) Inventor: TOVA TAL, HAIFA (IL)

(73) Assignee: SCENTCOM LTD., LEHAVOT HAVIVA (IL)

(21) Appl. No.: 15/256,708

(22) Filed: Sep. 5, 2016

Related U.S. Application Data
(63) Continuation of application No. PCT/IL2015/050193, filed on Feb. 19, 2015.

(30) Foreign Application Priority Data
Mar. 4, 2014 (GB) 1403750.1

(51) Int. Cl. A45D 8/34; A01N 65/22

(52) U.S. Cl. CPC A45D 8/34; A01N 65/22

(57) ABSTRACT

A scrunchie impregnated with rosemary oil. The scrunchie has an inner core that is enclosed by an outer layer. An intermittent layer, having holes, that is formed from an impervious material is located between the outer layer and the inner core. The inner core may contain core particles.

### CROSS REFERENCE TO RELATED APPLICATIONS

This application is a national stage entry of International Application PCT/IL2015/050193, entitled “Lice Rejecting Scrunchie”, filed Feb. 19, 2015; and claims priority from GB patent application 1403750.1, entitled “Lice Rejecting Scrunchie”, filed Mar. 4, 2014, the entire contents of which are incorporated herein by reference.

### FIELD OF THE INVENTION

The present invention relates to the field of lice rejecting accessories, and more particularly to the field of lice rejecting head accessories.

### BACKGROUND OF THE INVENTION

Lice are small wingless insects of the order Anoplura that are parasitic on humans and other mammals and having mouthparts adapted for sucking. Lice on humans are typically found on the scalp. They lay their eggs near to the hair roots, and after they reproduce they continue walking on the scalp and on the head hair.

Lice in the hair is a very unpleasant experience since they itch and cause the bearer to continuously scratch himself. Since children use to play together and have physical contact between their heads, there is greater tendency of lice to jump from one head of a child to another head, more than it occurs with adults.

There are various methods that were adopted during the years in order to fight lice in the scalp. According to one method, the scalp and hair are thoroughly washed with kerosene and then they are covered with a towel for a certain period of time in order to assure that all the lice and their eggs are dead. Then, the hair is thoroughly combed by means of a lice comb, which is a very dense comb, and finally the hair is washed several times. This method encounters several disadvantages. First, the contact between the kerosene and the hair and scalp is unhealthy and may cause irritations, dryness and accelerate hair molting. Second, despite the precautions taken by the parents, sometimes kerosene drops into the child's eyes, and causes severe irritations. Third, the treatment involves a very bad smell that may take several washes of the hair and scalp in order to remove the smell.

Other method to fight lice in the scalp involves melting margarine, and then, after it cools to a bearable temperature, it is poured into the hair. Then, since the margarine oil helps to dissolve the glue that glues the lice eggs to the hair roots, it is easier to comb the hair by means of a lice comb. Also this method encounters several disadvantages. First, the hair should be thoroughly washed for several times in order to remove the fatty margarine oil. Second, the margarine oil is smelly and the smell could be removed only after several washes. Third, caution must be taken care not to drop the margarine oil into the eyes.

There are a large number of chemical products in the market. Despite their effectiveness in cleaning the scalp and hair from lice and lice eggs, they cause damage in the long run, irritations, and accelerate hair molting.

In some cases, when repetitive treatments by the parents do not help to prevent long lasting lice-free head of the child, the parents decide to cut the entire head hair of the child. This process, though somewhat effective to fight lice, is traumatic to the child for many years to come.

U.S. Pat. No. 6,936,269 to Robinson discloses an insect repellent substrate for headwear. The insect repellent substrate (10) includes a fabric base material (12) made of felt which is impregnated with a repellent carrier composition (14). The carrier composition (14) includes a mixture of wax and a naturally occurring insect repellent such as pyrethrum oil. The carrier composition (14) may also include scented or aromatic oils such as citronella oil, rosemary oil, eucalyptus oil, and neem oil. Strips of the fabric base material may be attached to headwear such as a headband or cap so that it is in contact with the wearer's head or body. Active constituents of the carrier composition (14) provide effective treatment and prevention of head lice and other parasitic insects.

Since sometimes it is required only to prevent existence of lice in the hair, the total treatment against lice, and, other parasitic insects, makes the final product to be more expensive than required, especially if it has to include additional wax.

GB2435208 to Price discloses hair accessories with an insecticidal infusion. The hair accessories of '208 include hair bands, scrunchies, slides and combs, which have an infusion of insecticide to control infestations of head lice. Other devices, such as head bands, sweat bands, hair nets, necklaces or jewelry, may also be impregnated with an anti louse medication. Similarly impregnated strips may be produced for insertion into hats and caps.

Again, as mentioned above, the use of insecticidal infusions or medicines suffer from the mentioned disadvantages.

GB2456781 to Hunt discloses an hair band for treating the scalp and scalp hair. The hair band comprises a resiliently flexible member 11 that is arranged to fit over a person's head and which comprises means 12 for holding a treatment for treating the scalp and/or scalp hair. The hair band further comprises a cover which covers the means 12 for holding the treatment. The means 12 for holding the treatment may comprise absorbent pads possibly housed in a recess on the underside of the flexible member 11. The treatment may be suitable for removing head lice.

Despite the effectiveness of the hair band of '781, it is quite complex, and, therefore, may be more costly than required.

FR2634361 to Deban discloses a device, for human use, for preventing and eliminating lice. The invention relates to a device which is identical in appearance to that of a headband and is equipped with a rubberized strip containing a parasiticide to combat lice. It consists of a flexible ovoid support 1 whose concave face receives the band 2. The device is intended particularly for people who are infested with lice.

The device is somewhat similar to the hair band of '781, and it encounters similar disadvantages.

ES2199685 to Alvaro discloses a hair lice infestation prevention system that comprises a conventional head band coupled to an element (3) impregnated with, e.g., insecticide. The active product does not come into contact with the hair of the user.

In '685, the side effects that the user may get if he does not take the proper precautions to prevent contact with the active product are a major disadvantage for using this system. Furthermore, the construction of the system is not quite simple, hence, not cheap enough.

It is the object of the present invention to provide a lice rejecting product that significantly reduces or overcomes the aforementioned disadvantages.

It is a further object of the present invention to provide a lice rejecting product that is easy to implement and use.

It is still a further object of the present invention to provide a lice rejecting product that has a nice smell.

It is still yet a further object of the present invention to provide a lice rejecting product that is cheap to use and implement.

It is also an object of the present invention to provide a lice rejecting product that is efficient for a long period of time.

It is another object of the present invention to provide a method for lice rejecting.

### SUMMARY OF THE INVENTION

In accordance with the present invention there is provided a hair accessory impregnated with rosemary oil.

In some cases, the hair accessory constitutes a scrunchie.

Typically, the scrunchie comprises an outer layer.

If desired, the scrunchie comprises an inner core that is enclosed by the outer layer.

Advantageously, the scrunchie comprises an intermittent layer that is located between the outer layer and the inner core.

Further advantageously, the intermittent layer is made from an impervious material.

Preferably, the intermittent layer comprises holes.

In some embodiments, the scrunchie comprises an intermittent layer, enclosed by the outer layer, and core particles that are enclosed by the intermittent layer.

If desired, the inner core is impregnated with rosemary oil prior to being enclosed by the outer layer.

Further if desired, the core particles are impregnated with rosemary oil prior to being enclosed by the intermittent layer or by the outer layer.

Further in accordance with the present invention there is provided a method for producing a lice rejecting hair accessory, the method comprising the steps of:
(a) Providing a hair accessory.
(b) Impregnating the hair accessory with rosemary oil.

Still further in accordance with the present invention there is provided a method for producing a lice rejecting hair accessory, the method comprising the steps of:
(a) Providing a hair scrunchie having an outer layer.
(b) Impregnating the scrunchie with rosemary oil.

If desired, the method further comprising after step (a) the step of:
(c) Providing an inner core that is enclosed by the outer layer.

Further if desired, the method further comprising after step (c) the step of:
(d) Providing an intermittent layer between the outer layer and the inner core, the intermittent layer being formed with holes and is made from an impervious material.

Still further if desired, the method further comprising after the step (a) of providing a hair scrunchie having an outer layer, the step of: (c)

Providing core particles that are enclosed by the outer layer.

Still yet further in accordance with the present invention there is provided a method for producing a lice rejecting scrunchie, the method comprising the steps of:
(a) Providing an inner core or core particles.
(b) Impregnating the inner core or the core particles with rosemary oil.
(c) Providing an outer layer of the scrunchie.
(d) Enclosing the inner core or the core particles by the outer layer.

If desired, the method further comprising after step (d) the step of:
(e) Impregnating the scrunchie with rosemary oil.

Still in accordance with the present invention there is provided a lice rejecting sticker for being attached to a head accessory, the sticker comprises a rosemary oil absorbing substance in a first side of the sticker, and, a sticky tape in another side of the sticker, opposite the first side, and wherein the oil absorbing substance is impregnated with rosemary oil, and the sticky tape is attached to an inner portion of a head wearing accessory.

### BRIEF DESCRIPTION OF THE DRAWINGS

For a better understanding of the present invention and to show how the same may be carried out in practice, reference will now be made to the accompanying drawings, in which:

FIG. 1 is a perspective view of a lice rejection scrunchie according to the present invention;

FIG. 2 is a cross-sectional view of the lice rejection scrunchie of FIG. 1, according to a first embodiment;

FIG. 3 is a cross-sectional view of the lice rejection scrunchie of FIG. 1, according to a second embodiment;

FIG. 4 is a cross-sectional view of the lice rejection scrunchie of FIG. 1, according to a third embodiment;

FIG. 5 is a cross-sectional view of the lice rejection scrunchie of FIG. 1, according to a fourth embodiment;

FIG. 6 is a side view of a lice rejection sticker according to the present invention;

FIG. 7 is a top perspective view of the lice rejection sticker of FIG. 6; and

FIG. 8 is a bottom perspective view of the lice rejection sticker of FIG. 6.

### DETAILED DESCRIPTION OF THE INVENTION

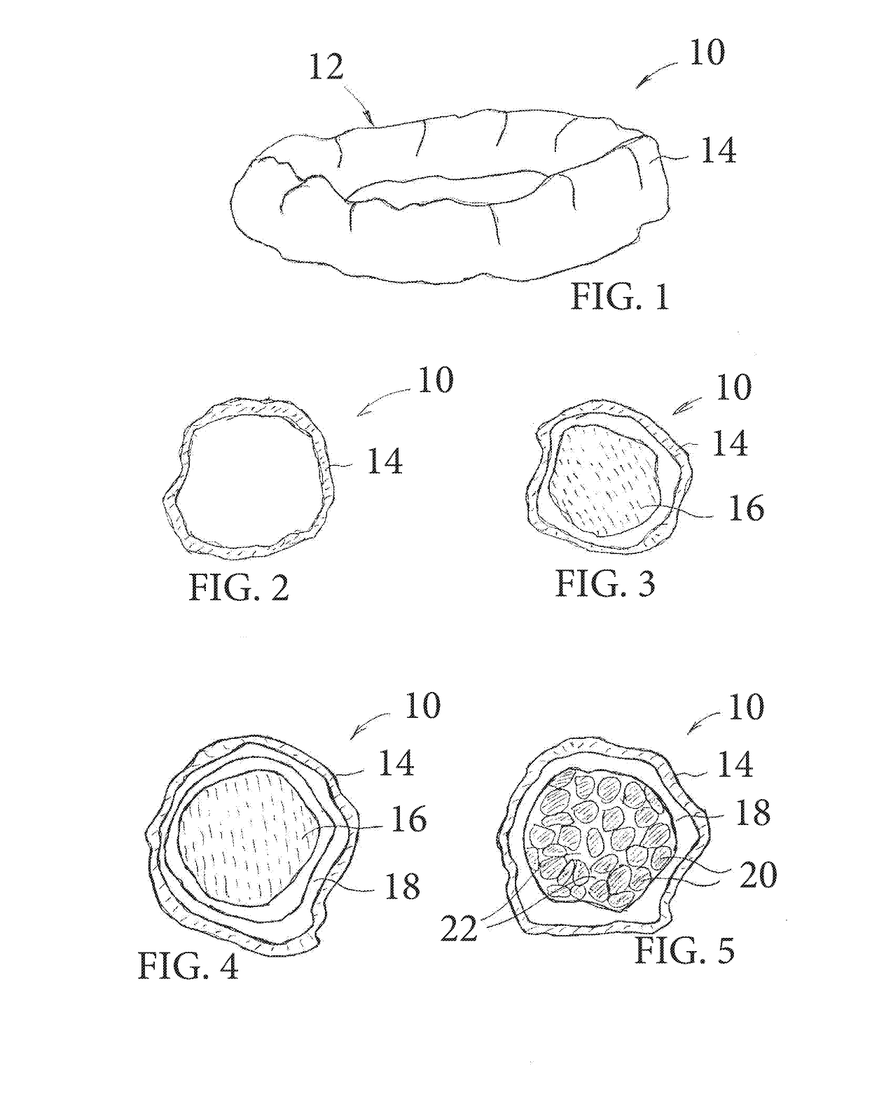

Attention is drawn to FIGS. 1 and 2 that show a lice rejection scrunchie 10 according to the present invention. The scrunchie 10, also known as a ponytail holder, is of a conventional form and has a general toroid shape 12. The scrunchie 10 has an outer layer 14 that is typically made of fabric. According to some embodiments, the fabric may be velvet or have a texture of velvet. According to other embodiments, the fabric may have a texture like that of a towel. Likewise, the fabric may have a texture of a plain cloth, wool, or the like.

The scrunchie is provided with circumferentially arranged rubber strings (not shown in the figures) that are attached, embedded, connected, or stitched to the fabric. In a non-used position of the scrunchie, the rubber strings are in a non-tensioned position. When it is desired to use the scrunchie, i.e., to put it on a ponytail or a braid, the scrunchie is radially outwardly tensioned, hence tensioning the rubber strings. Upon putting the scrunchie in position, the tension applied on the scrunchie is released, and the rubber strings bring the scrunchie into a tight position onto the ponytail or braid.

It should be noted that directional terms appearing throughout the specification and claims, e.g. “forward”, “rear”, “upper”, “lower” etc., are used as terms of convenience to distinguish the location of various surfaces relative to each other. These terms are defined with reference to the figures, however, they are used for illustrative purposes only, and are not intended to limit the scope of the appended claims.

In order to provide a cheap, simple and efficient lice rejecting scrunchie, the scrunchie 10 is impregnated with rosemary oil. Then, the scrunchie 10 is taken out of the oil and hanged until the loosed oil, which was not impregnated in the scrunchie 10, drops out from the scrunchie 10, and the scrunchie 10 is ready for use.

When the scrunchie 10 is put on the hair, the odor of the rosemary oil rejects lice, thus prevent them from getting on the user hair and scalp for several days. Furthermore, the odor of the rosemary oil is gentle and pleasant to the human sense of smell.

FIG. 3 shows another embodiment of the present invention. As shown in FIG. 3, the scrunchie 10 comprises an outer layer 14 and an inner core 16 that is enclosed by the outer layer 14. The inner core 16 provides means for absorbing and maintaining a large quantity of rosemary oil. The inner core 16 may be formed from a sponge, fabric, or other porous substance, according to specific needs. Thus, after the scrunchie 10 is impregnated with rosemary oil, a larger quantity of oil may be impregnated into the outer layer 14 and into the inner core 16 thus providing longer sustainability of the rosemary oil and rosemary odor within the scrunchie 10.

FIG. 4 shows another embodiment of the present invention. As shown in FIG. 4, the scrunchie 10 is provided with an intermittent layer 18 between the outer layer 14 and the inner core 16. The intermittent layer 18 is preferably made from an impervious material, such as plastic or the like, and is provided with tiny holes (not shown in the figures). The role of the intermittent layer 18 is to serve as an odor escape retardant. The size and distribution of the holes is determined according to odor retardant needs.

Thus, in a first aspect, the scrunchie of FIG. 4 is able to gather a large quantity of rosemary oil by penetrating through the tiny holes and accumulating into the inner core 16, and, in a second aspect, the scrunchie 10 is able to retard loosing the rosemary odor as much as required, by amending the size of the tiny holes and their distribution.

FIG. 5 shows another embodiment of the present invention. As shown in FIG. 5, the scrunchie 10 is provided with an outer layer 14 and with an intermittent layer 18 as described above. An inner portion of the intermittent layer 18 is filled with a multitude of core particles 20.

The core particles 20 may be formed from a sponge, fabric, or other porous material. Furthermore, the core particles may be formed from polyurethane, which is a thermoplastic polymer that is used for padding and insulation in clothing and the like. The core particles 20 have the basic function of the inner core 16, however, they encounter several advantages over the core 16 that was described above. First, the core particles 20, as being small particles, are cheaper than a bulky inner core 16. Second, the core particles 20 are easier implemented than the bulky inner core 16. Third, since the core particles 20 have a larger surface area as compared with the inner core 16, they may accumulate a larger quantity of rosemary oil on their surface as compared with the quantity accumulated on the surface of the inner core 16. Fourth, more rosemary oil may be gathered within voids 22 formed between the core particles 20 as compared with the bulky inner core 16.

According to some manufacturing processes, the inner core 16, or, alternatively, the core particles 20, are first separately impregnated with rosemary oil prior to their covering, being by the intermittent layer 18, or, directly, by the outer layer 14.

In some embodiments, after enclosing the pre-impregnated inner core 16 or the core particles 20, the scrunchie 10 may be impregnated again as a whole.

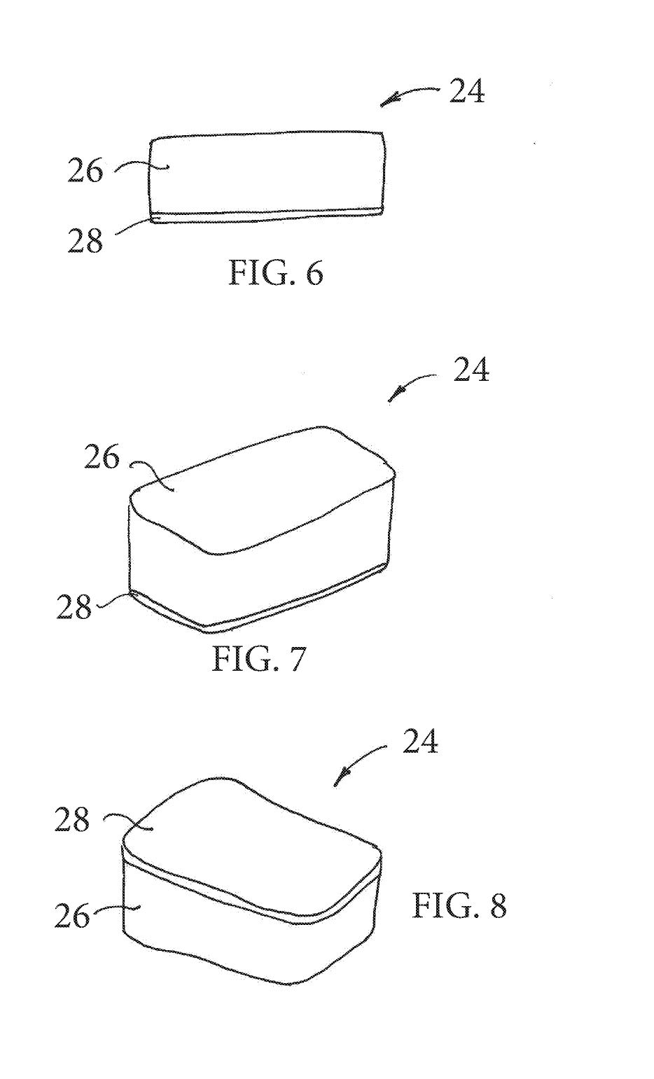

According to some embodiments, as shown in FIG. 6, small stickers 24 are impregnated with rosemary oil. The stickers 24 comprise a rosemary oil absorbing substance 26 in a first side thereof, and, a sticky tape 28 in another side of the stickers, opposite the first side. The rosemary oil absorbing substance 26 may have various textures, like, e.g., sponge, cloth, woven fabric, non-woven fabric, velvet-like, polyurethane, or any other suitable porous material.

The impregnated stickers 24 may be attached, by means of the sticky tapes 28 thereof, to an inner portion of a head wearing accessory, like, e.g, hair band, hair brooch, hat, skullcap, yarmulke, kerchief, bandana, head scarf, and the like.

According to some embodiments, the entire head wearing accessories listed above are impregnated with rosemary oil.

Thus, as described above, and having advantages over the prior art, the present invention discloses a lice rejecting scrunchie. The scrunchie is impregnated with rosemary oil which produces odor that rejects lice. The scrunchie is provided with various options for controlling the absorption of rosemary oil within the scrunchie, and, with various options for controlling the rate of evaporation of the odor out of the scrunchie.

Although the present invention has been described to a certain degree of particularity, it should be understood that various alterations and modifications could be made without departing from the spirit or scope of the invention as hereinafter claimed.

For example, the scrunchie does not have to be made of fabric and other materials and textures may be applied as well, like leather, leather imitation, plastic, rubber, and the like.

The present invention is not limited to be used on a scrunchie, and it is equally applicable on other hair accessories as well, e.g., sweat band, hair net, hair cover, kerchief, cap, and the like.

Furthermore, the invention is not limited to soft and fabric like accessories, and it may be applicable to harder or solid accessories like comb, hair pin, hair band, brooch, hair clip, and the like.

In some embodiments, the intermittent layer may be omitted. In those cases, the core particles may be directly enclosed by the outer layer.

The intermittent layer does not have to be made from an impervious material. In some cases, the role of the intermittent layer is solely to hold together the core particles prior to them being enclosed by the outer layer. In those cases, the intermittent layer is formed like a net or the like.

The stickers may be square, round, oval, or have any other desired shape.

1. A hair accessory impregnated with rosemary oil.

2. The hair accessory according to claim 1, wherein the hair accessory comprises a scrunchie having an outer layer.

3. The hair accessory according to claim 2, wherein the scrunchie comprises an inner core that is enclosed by the outer layer.

4. The hair accessory according to claim 3, wherein the scrunchie comprises an intermittent layer that is located between the outer layer and the inner core.

5. The hair accessory according to claim 4, wherein the intermittent layer is made from an impervious material.

6. The hair accessory according to claim 4, wherein the intermittent layer comprises holes.

7. The hair accessory according to claim 3, wherein the scrunchie comprises an intermittent layer, enclosed by the outer layer, and core particles that are enclosed by the intermittent layer or by the outer layer.

8. The hair accessory according to claim 7, wherein the core particles are impregnated with rosemary oil prior to being enclosed by the intermittent layer or by the outer layer.

9. A method for producing a lice rejecting hair accessory, the method comprising the steps of:
(a) providing a hair accessory; and
(b) impregnating the hair accessory with rosemary oil.

10. The method according to claim 9, further comprising after step (a) the step of:
(c) providing an inner core that is enclosed by an outer layer.

11. The method according to claim 10, further comprising after step (c) the step of:
(d) providing an intermittent layer between the outer layer and the inner core, the intermittent layer being formed with holes and is made from an impervious material.

12. The method according to claim 11, further comprising after step (a) the step of:
(e) providing core particles that are enclosed by the outer layer.

13. The method according to claim 12, further comprising after step (e) the step of:
(f) providing an intermittent layer between the core particles and the outer layer.

14. A method for producing a lice rejecting scrunchie, the method comprising the steps of:
(a) providing an inner core or core particles;
(b) impregnating the inner core or the core particles with rosemary oil;
(c) providing an outer layer of the scrunchie;
(d) enclosing the inner core or the core particles by the outer layer.

15. (canceled)
